(19) United States
(12) Patent Application Publication
(10) Pub. No.: US 2010/0328555 A1
(43) Pub. Date: Dec. 30, 2010

(54) LIGHTING DEVICE, DISPLAY DEVICE AND TELEVISION RECEIVER

(76) Inventor: Yasumori Kuromizu, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/746,004

(22) PCT Filed: Jul. 25, 2008
(86) PCT No.: PCT/JP2008/063378

§ 371 Date: Sep. 2, 2010

(30) Foreign Application Priority Data
Dec. 7, 2007 (JP) 2007-317045

(51) Int. Cl. H04N 3/14; F21V 7/00; F21V 5/00; G02F 1/13357; G02F 1/1335

(52) U.S. Cl. 348/790; 362/235; 362/97.1; 349/62; 348/E03.016

(57) ABSTRACT

A lighting device 12 of the present invention includes a plurality of linear light sources 17 arranged parallel to one another, and a diffuser plate 31 arranged on the light emitting side of the linear light sources 17. The linear light sources 17 are arranged so that a narrow-interval area 17a where the arrangement interval thereof is relatively narrow and a wide-interval area 17b where the arrangement interval is relatively wide are provided. A dot pattern as an array of a plurality of dots 40 is provided on the diffuser plate 31. The dots 40 have a light reflectivity that differs from the light reflectivity of the diffuser plate 31. The light reflectivity provided by a combination of the diffuser plate 31 and the dot pattern is set to decrease continuously and gradually from the area corresponding to the narrow-interval area 17a toward the area corresponding to the wide-interval area 17b.

### TECHNICAL FIELD

The present invention relates to a lighting device, a display device and a television receiver.

### BACKGROUND ART

In a display device having non-luminous optical elements as typified by a liquid crystal display device, a backlight device is provided on the backside of a display panel such as a liquid crystal panel, so as to illuminate the display panel. For instance, the backlight device, arranged on the backside of the liquid crystal panel (i.e., on the opposite side of the display surface), includes a chassis having an opening on the liquid crystal panel side, and further includes a number of lamps (e.g., cold cathode tubes) contained in the chassis. Further included is an optical member, which is arranged in the opening of the chassis and includes a diffuser plate for converting lights from the cold cathode tubes into flat lights.

Following the recent increase in brightness and size of a display panel, the number of cold cathode tubes arranged in the backlight device has been increasing. However, the increase in the number of cold cathode tubes directly leads to increase in power consumption, and further may cause temperature rise in the display panel, resulting in reliability degradation thereof. In this connection, Patent Document 1 discloses a technique for preventing the increase in power consumption of the backlight device, focusing on an array configuration of the cold cathode tubes.

### Patent Document 1: JP-B-3642723

### Problem to be Solved by the Invention

The backlight device, disclosed in Patent Document 1 described above, has a construction that includes a plurality of straight tube lamps to be arranged substantially parallel along the horizontal or longitudinal direction of the display screen of a display panel. The intervals between the straight tube lamps are set to be narrower at the central area of the display screen of the display panel and to increase at a constant rate towards the upper or lower end of the display screen (which is also referred to as an unequal lamp-pitch structure). In general, people pay attention to the center of the screen, and therefore don't mind if the end of the screen has brightness slightly lower than that of the center of the screen. Focusing on this tendency, the above construction allows for reduction in number of lamps and therefore in power consumption while maintaining the uniformity in brightness of the surface light source.

In the unequal lamp-pitch structure as in Patent Document 1, the brightness distribution on the entire screen is extremely sensitive to the arrangement of lamps. Therefore, the end of the screen may be prone to display unevenness, such as brightness unevenness due to shortage of the light amount attributable to the wide intervals between lamps, or visible images of lamps due to insufficient reflection of the lights.

One of possible means for preventing the display unevenness is to absorb the lights from the lamps and thereby reduce the brightness at the central area of the display screen where the lamp intervals are narrow. However, the means thus simply absorbing the lights from the lamps will cause the reduction in the overall brightness of the backlight device, which results in failure to maintain a high level of brightness.

### DISCLOSURE OF THE INVENTION

The present invention was made in view of the foregoing circumstances, and an object thereof is to provide a lighting device capable of providing a gentle distribution of illumination brightness by partially regulating the illumination brightness while effectively using the lights from linear light sources. A further object of the present invention is to provide a display device having the lighting device, and to provide a television receiver having the display device.

### Means for Solving the Problem

In order to solve the above problem, a lighting device according to the present invention includes a plurality of linear light sources arranged parallel to one another, and a diffuser plate arranged on the light emitting side of the linear light sources. The linear light sources are arranged so that a narrow-interval area where the arrangement interval thereof is relatively narrow and a wide-interval area where the arrangement interval is relatively wide are provided. A dot pattern as an array of a plurality of dots is provided on the diffuser plate. The dots have a light reflectivity that differs from the light reflectivity of the diffuser plate. The light reflectivity provided by a combination of the diffuser plate and the dot pattern is set to decrease continuously and gradually from the area corresponding to the narrow-interval area toward the area corresponding to the wide-interval area.

In the present lighting device, a sufficient level of illumination brightness can be provided at the narrow-interval area of the linear light sources, while the number of linear light sources to be used therein can be reduced due to the relatively wide interval at the wide-interval area, resulting in contribution to cost reduction.

In the case of some applications of the lighting device, it is preferable that an area with high illumination brightness is provided partly and separately from an area with low illumination brightness. For example, in the case of a display device that provides display by use of the present lighting device, a bright display may be required on the inner side (or central area) of the display screen while a brighter display is not required on the outer side (or peripheral area) of the display screen. In this case, it is preferable that the narrow-interval area is arranged on the inner side of the display screen while the wide-interval area is arranged on the outer side of the display screen.

However, when the linear light sources are arranged at intervals of varying length as described above, it is important that the narrow-interval area capable of providing relatively high illumination brightness and the wide-interval area capable of providing relatively low illumination brightness are arranged in a balanced manner. If the illumination brightness differs excessively between the narrow-interval area and the wide-interval area, the entire distribution of illumination brightness may be provided as an uneven distribution, resulting in brightness unevenness in a display device that uses the present lighting device, for example.

According to the present invention, the dots differing in light reflectivity from the diffuser plate are additionally provided on the diffuser plate in the above construction having linear light sources arranged at intervals of varying length, so that the light reflectivity provided by a combination of the diffuser plate and the dots decreases continuously and gradually from the area corresponding to the narrow-interval area of the linear light sources toward the area corresponding to the wide-interval area. According to the construction, the illumination brightness can be gently distributed over the entire lighting device while the lights from the linear light sources are effectively used.

The linear lights from the linear light sources are converted by the diffuser plate into fiat lights, and are outputted as a uniform illumination light. At the time, the lights from the linear light sources are mostly transmitted through the diffuser plate, while the lights are partly reflected by the surface of the diffuser plate. In this regard, the inventor of the present application has found that the amount of light to be transmitted through the diffuser plate and the amount of light to be reflected by the diffuser plate can be controlled by providing the dots on the surface of the diffuser plate, which differ in light reflectivity from the diffuser plate. Thus, the partial regulation of the illumination brightness can be achieved. Specifically, the light reflectivity of the diffuser plate can be set to be relatively high at the area corresponding to the narrow-interval area prone to relatively high illumination brightness, while it can be set to be relatively low at the area corresponding to the wide-interval area prone to relatively low illumination brightness. In this way, the adjustment of illumination brightness between the narrow-interval area and the wide-interval area can be achieved.

Particularly, the light reflectivity provided by a combination of the diffuser plate and the dots is set to decrease continuously and gradually from the area corresponding to the narrow-interval area of the linear light sources toward the area corresponding to the wide-interval area. Compared to varying the light reflectivity step by step, for example, the present construction can provide a further gentle distribution of illumination brightness, because the illumination brightness can vary continuously instead of step by step.

Some aspects of the present invention provide variations of arrangement intervals of the linear light sources. For example, the linear light sources may be arranged so that the narrow-interval area of the linear light sources is positioned in the array direction of the linear light sources so as to be on the center side while the wide-interval area is positioned in the array direction of the linear light sources so as to be on an end side.

In the lighting device of the present invention, the light reflectivity of the dots may be set to be higher than the light reflectivity of the diffuser plate. The dot pattern can be provided so that the dot-pattern ratio as a ratio of an area occupied by the dot pattern in the whole of the diffuser plate decreases continuously and gradually from the area corresponding to the narrow-interval area toward the area corresponding to the wide-interval area.

In the present construction, the lights reflected by the dots having a higher light reflectivity than the diffuser plate can be further reflected, for example, by a light reflecting sheet that can be arranged across the linear light sources from the diffuser plate. Then, the reflected lights enter the diffuser plate again. In this way, the lights from the linear light sources can be effectively used. Further, even at the wide-interval area prone to relatively low illumination brightness, the brightness can be enhanced as a result of the repetitive reflection between the diffuser plate and the light reflecting sheet.

In the present construction, the amount of light to be reflected by a combination of the diffuser plate and the dots increases with increase in the dot-pattern ratio. Accordingly, the amount of light to be reflected decreases while the amount of light to be transmitted through the diffuser plate increases, from the narrow-interval area toward the wide-interval area. In this way, the amount of light to be reflected is set to be large at the narrow-interval area prone to relatively high illumination brightness, while it is set to be small at the wide-interval area prone to relatively low illumination brightness. Consequently, the illumination brightness can be gently distributed over the entire lighting device.

Moreover, the dot-pattern ratio is set to decrease continuously and gradually. Therefore, the dot pattern is less visible on a display device that uses the present lighting device, for example. In the display device, the diffuser plate is arranged on the display panel side of the linear light sources (i.e., arranged closer to a viewer). Therefore, the boundaries where the dot-pattern ratio varies may be visible, if the dot-pattern ratio varies step by step, for example. However, according to the present invention, the dot-pattern ratio is set to decrease continuously and gradually from the area corresponding to the narrow-interval area toward the area corresponding to the wide-interval area. That is, the dot-pattern ratio varies without producing boundaries. Consequently, the dot pattern can be prevented from being visible to the viewer.

The distance between the diffuser plate and the array of the linear light sources may be set to be constant along the surface of the diffuser plate.

If the distance between the diffuser plate and the linear light sources is not constant, the amount of emitted light reaching the diffuser plate differs among the linear light sources. In this case, linear light sources arranged at a relatively small distance from the diffuser plate may be visible as lamp images on a display device that uses the present lighting device, for example. However, according to the present invention, the distance between the diffuser plate and the linear light sources is set to be constant. Consequently, the visible images of lamps may be prevented, and a high quality of display can be achieved.

The above dots may include a plurality of dots arranged along the axial direction of the linear light sources. The intervals between the dots adjacently arranged in the axial direction can be set to increase consecutively and gradually from the area corresponding to the narrow-interval area toward the area corresponding to the wide-interval area.

The above dots may include a plurality of dots arranged in the array direction of the linear light sources. The intervals between the dots adjacently arranged in the array direction can be set to increase consecutively and gradually from the area corresponding to the narrow-interval area toward the area corresponding to the wide-interval area.

According to any of these constructions, the dot-pattern ratio can be set to a desired value by adjusting the intervals between the dots. Specifically, the intervals between the dots are set to increase consecutively and gradually from the area corresponding to the narrow-interval area of the linear light sources toward the area corresponding to the wide-interval area, which results in a larger number of dots provided in the area corresponding to the narrow-interval area. In this way, the dot-pattern ratio can be set to decrease continuously from the area corresponding to the narrow-interval area toward the area corresponding to the wide-interval area. The dots have a higher light reflectivity than the diffuser plate, and therefore the amount of light to be reflected can be larger (i.e., the amount of light to be transmitted through the diffuser plate can be smaller) at the narrow-interval area due to the higher dot-pattern ratio. Thus, the illumination brightness at the narrow-interval area is reduced, and thereby the difference in brightness between the narrow-interval area and the wide-interval area can be reduced.

The planar dimensions of the dots may be set to decrease consecutively and gradually from the area corresponding to the narrow-interval area toward the area corresponding to the wide-interval area.

According to the construction, the dot-pattern ratio can be set to a desired value by adjusting the planar dimensions (or sizes) of the dots. Specifically, the planar dimensions of the dots are set to decrease consecutively and gradually from the area corresponding to the narrow-interval area of the linear light sources toward the area corresponding to the wide-interval area. Thereby, the dot-pattern ratio can be set to decrease continuously from the area corresponding to the narrow-interval area toward the area corresponding to the wide-interval area. The dots have a higher light reflectivity than the diffuser plate, and therefore the amount of light to be reflected can be larger (i.e., the amount of light to be transmitted through the diffuser plate can be smaller) at the narrow-interval area due to the higher dot-pattern ratio. Thus, the illumination brightness at the narrow-interval area is reduced, and thereby the difference in brightness between the narrow-interval area and the wide-interval areas can be reduced.

The dots may be colored with white.

The dots with white color can be highly light-reflective, and therefore can differ more greatly in light reflectivity from the diffuser plate. Consequently, the dot pattern can function as a regulator for light reflection, more effectively.

The dots may include a fluorescent whitener.

Alternatively, the dots may be formed to have a surface with metallic luster.

In the case of the dot pattern thus including the dots formed by application of a fluorescent whitener as a highly light-reflective material or the dots having a surface with metallic luster, the dots have an increased light reflectivity, and therefore can differ more greatly in light reflectivity from the light reflecting member. Consequently, the dot pattern can function as a regulator for light reflection, more effectively.

The plurality of dots in the dot pattern may be arranged in a zigzag pattern.

Alternatively, the plurality of dots in the dot pattern may be arranged in parallel lines.

According to any of these constructions, the light reflection can be regulated with improved accuracy, due to the regular arrangement of the dots.

The dot pattern can be formed on the diffuser plate by printing.

Alternatively, the dot pattern can be formed on the diffuser plate by metal deposition.

The dot pattern, which is thus to be formed by printing or metal deposition, can be arbitrarily designed and be readily formed as designed.

A lens sheet having an array of a plurality of lenses may be attached to a surface of the diffuser plate that is on the opposite side of a surface facing the linear light sources.

According to the construction, the lights after being diffused by the diffuser plate can pass through the lenses of the lens sheet, and thereby the irradiation light can be condensed into the effective display area of a display panel with high efficiency when the present lighting device is used in a display device, for example.

Further, a reflective layer may be provided between the diffuser plate and the lens sheet, so as to reflect light emitted from the linear light sources. The reflective layer can be selectively arranged to correspond to a boundary area between the plurality of lenses.

According to the construction, the reflective layer is arranged to correspond to the non-converging sections of the lenses, while opening sections are arranged between adjacent sections of the reflective layer so as to correspond to the converging sections of the lenses. In the construction, the light diffusion angle (or the light converging angle) can be readily controlled by adjusting the area ratio between the reflective layer sections and the opening sections. Thereby, in a display device using the present lighting device, the lights to be directed to the nondisplay area can be reduced, resulting in improvement in light use efficiency.

Alternatively, a lens pattern as an array of a plurality of lenses may be provided on a surface of the diffuser plate that is on the opposite side of a surface facing the linear light sources.

According to the construction, the lights after being diffused by the diffuser plate can pass through the lens pattern, and thereby the irradiation light can be condensed into the effective display area of a display panel with high efficiency when the present lighting device is used in a display device, for example.

In order to solve the above problem, a display device according to the present invention includes a lighting device described above, and a display panel arranged to provide display by use of light from the lighting device.

In the present display device, the illumination brightness is gently distributed over the lighting device, and thereby display unevenness can be prevented or suppressed in the display device.

A liquid crystal panel can exemplify the above display panel. The display device as a liquid crystal display device has a variety of applications, such as a television display or a personal-computer display. Particularly, it is suitable for a large-screen display.

A television receiver according to the present invention includes a display device described above.

The present television receiver can achieve a high quality of display, because the display unevenness can be prevented or suppressed in the display device.

### EFFECT OF THE INVENTION

The present invention can provide a lighting device capable of providing a gentle distribution of illumination brightness by partially regulating the illumination brightness while effectively using the lights from linear light sources. Further, a display device of the present invention can provide high-quality display in which display unevenness is prevented or suppressed. A television receiver of the present invention can provide high-quality TV pictures in which display unevenness is prevented or suppressed.

### BRIEF DESCRIPTION OF THE DRAWINGS

FIG. 1 is an exploded perspective view showing the general construction of a television receiver according to an embodiment 1 of the present invention;

FIG. 2 is an exploded perspective view showing the general construction of a liquid crystal display device included in the television receiver shown in FIG. 1;

FIG. 3 is a sectional view showing the construction of the liquid crystal display device of FIG. 2 along the line A-A;

FIG. 4 is a plan view schematically showing the construction of a diffuser plate that is included in an optical member arranged in the liquid crystal display device shown in FIG. 2;

FIG. 5 is an explanatory diagram schematically showing the operational effects of the diffuser plate shown in FIG. 4;

FIG. 6 is a plan view schematically showing the construction of a diffuser plate to be arranged in a liquid crystal display device according to an embodiment 2;

FIG. 7 is a perspective view showing the construction of an optical member to be arranged in a liquid crystal display device according to an embodiment 3;

FIG. 8 is a sectional view showing the construction of the optical member of FIG. 7 along the line B-B;

FIG. 9 is an explanatory diagram showing a modification of a dot pattern;

FIG. 10 is an explanatory diagram showing another modification of the dot pattern;

FIG. 11 is an explanatory diagram showing another modification of the dot pattern;

FIG. 12 is an explanatory diagram showing another modification of the dot pattern;

FIG. 13 is an explanatory diagram showing another modification of the dot pattern;

FIG. 14 is an explanatory diagram showing another modification of the dot pattern;

FIG. 15 is an explanatory diagram showing another modification of the dot pattern;

FIG. 16 is an explanatory diagram showing another modification of the dot pattern;

FIG. 17 is an explanatory diagram showing another modification of the dot pattern;

FIG. 18 is a perspective view showing a modification of the optical member; and

FIG. 19 is a sectional view showing the construction of the optical member of FIG. 18 along the line C-C.

### EXPLANATION OF SYMBOLS

10: Liquid crystal display device (Display device), 11: Liquid crystal panel (Display panel), 12: Backlight device (Lighting device), 17: Cold cathode tube (Linear light source), 17a: Narrow-interval area of cold cathode tubes, 17b: wide-interval area of cold cathode tubes, 31, 51, 61: Diffuser plate, 33,62: Lens sheet, 40,50: Dot, 64: Convex cylindrical lens (Lens), 66: Reflective layer, TV: Television receiver.

### BEST MODE FOR CARRYING OUT THE INVENTION

### Embodiment 1

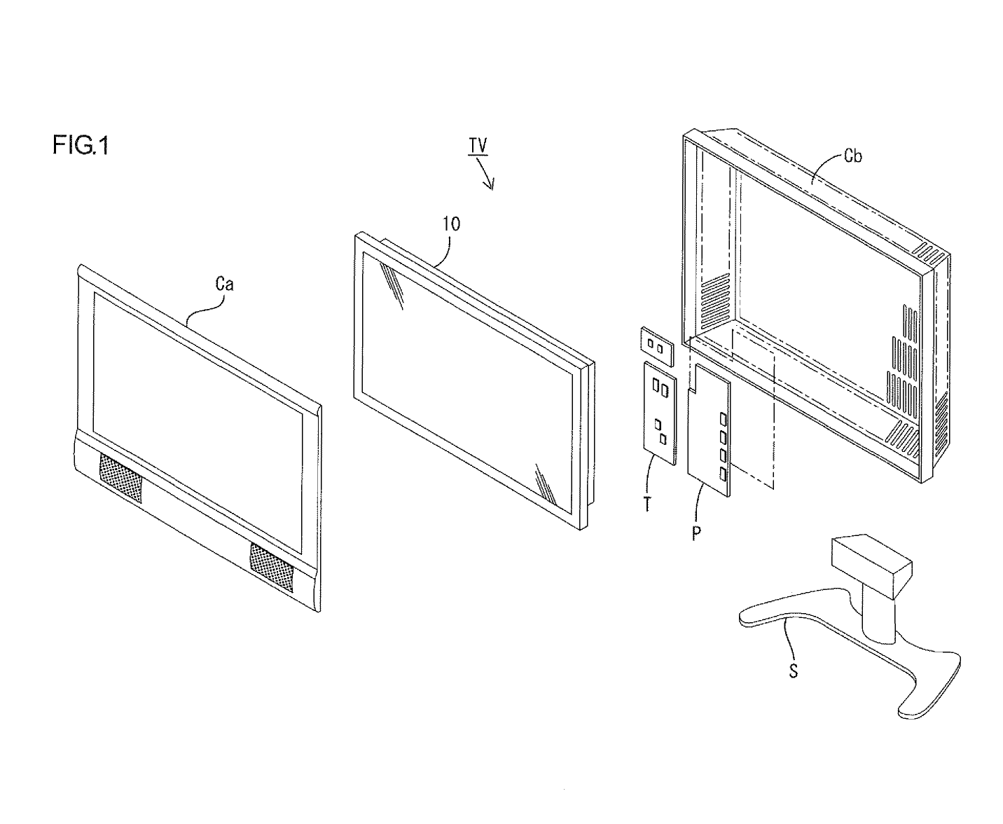

An embodiment 1 according to the present invention will be explained with reference to FIGS. 1 to 5. In the present embodiment, a television receiver TV having a liquid crystal display device 10 will be illustrated.

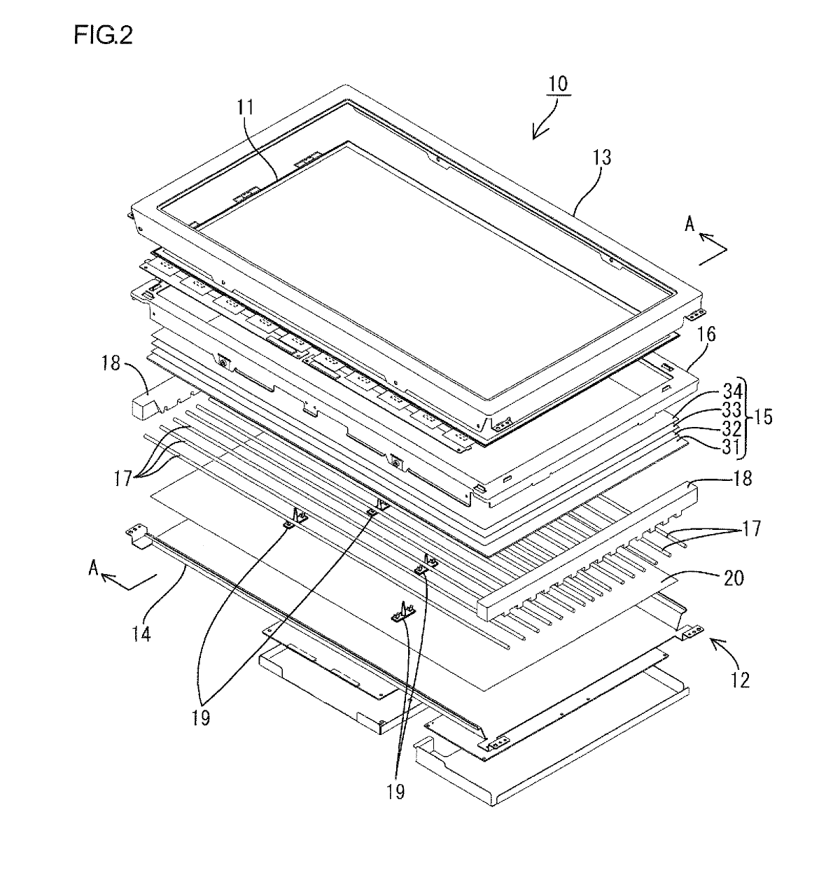

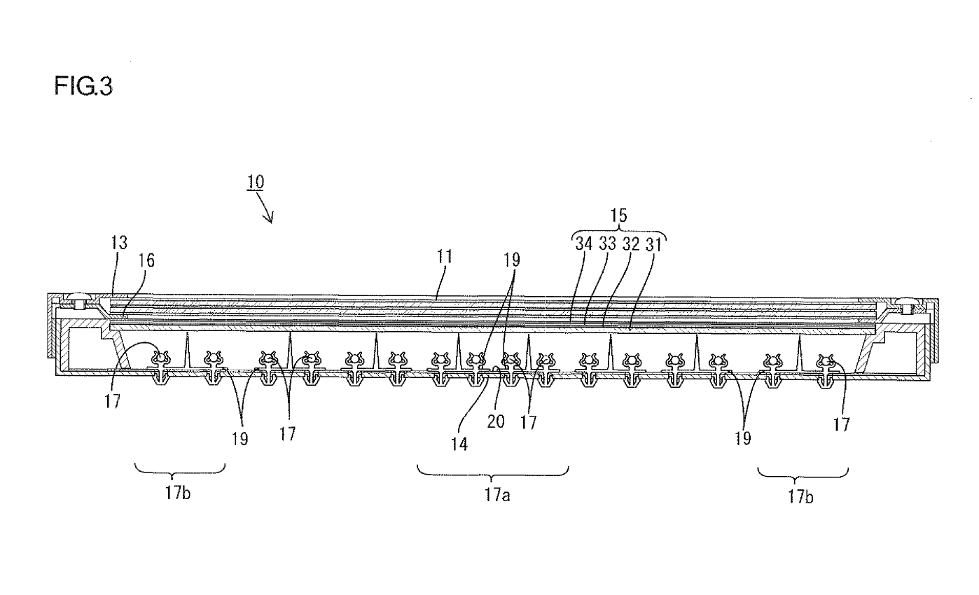

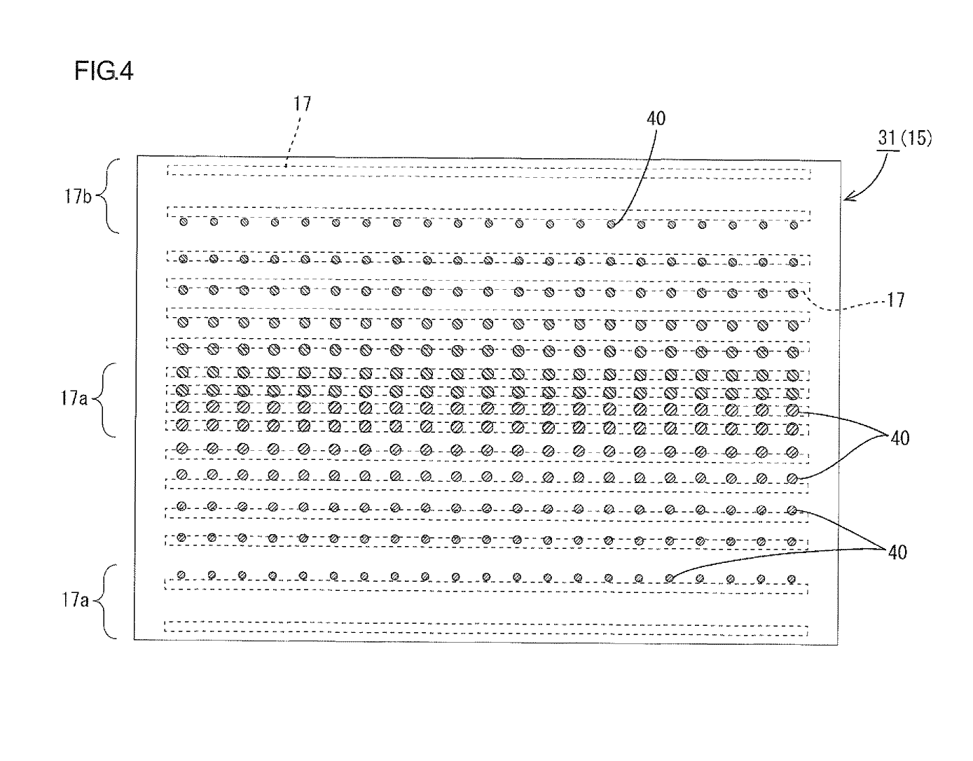

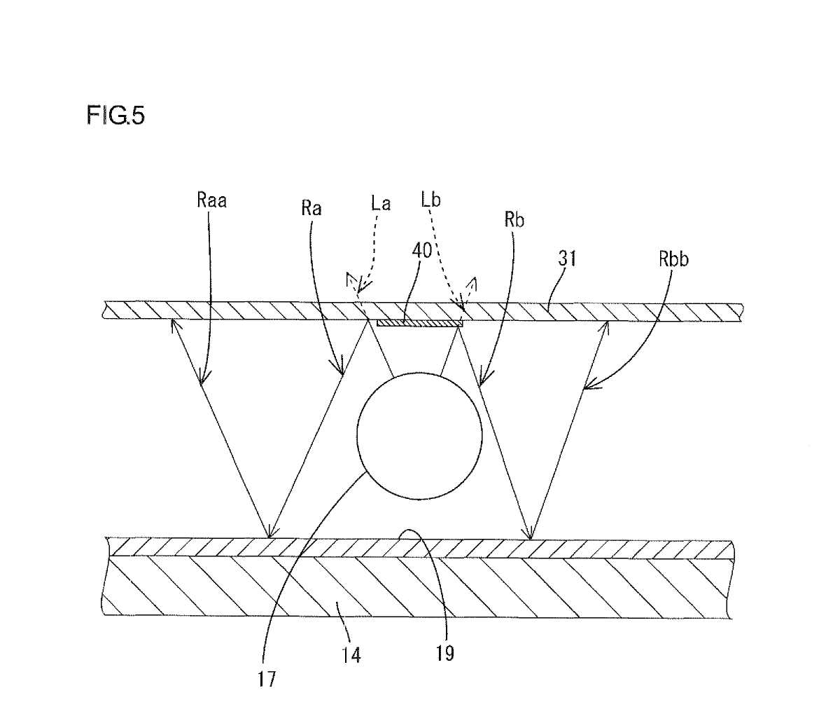

FIG. 1 is an exploded perspective view showing the general construction of the television receiver according to the present embodiment. FIG. 2 is an exploded perspective view showing the general construction of the liquid crystal display device. FIG. 3 is a sectional view showing the construction of the liquid crystal display device along the line A-A. FIG. 4 is a plan view schematically showing the construction of a diffuser plate that is included in an optical member arranged in the liquid crystal display device. FIG. 5 is an explanatory diagram schematically showing the operational effects of the diffuser plate.

Referring to FIG. 1, the television receiver TV according to the present embodiment includes the liquid crystal display device 10, and front and back cabinets Ca and Cb capable of holding the liquid crystal display device 10 therebetween. Further included are a power source P, a tuner T and a stand S. The liquid crystal display device (display device) 10, held therein, forms a horizontally-elongated rectangular shape as a whole, which is arranged in an upright position so that the short side thereof extends along the vertical direction. Referring to FIG. 2, the liquid crystal display device 10 includes a liquid crystal panel 11 as a display panel and a backlight device 12 as an external light source, which are integrally held by a bezel 13 and the like.

Next, the liquid crystal panel 11 and the backlight device 12 of the liquid crystal display device 10 will be explained (See FIGS. 2 and 3).

The liquid crystal panel (as a display panel) 11 includes a pair of glass substrates, which are attached to each other so as to face each other while a gap of a predetermined size is kept therebetween. Liquid crystal is sealed between the glass substrates. On one of the glass substrates, components such as switching elements (e.g., TFTs) connected to source wiring lines and gate wiring lines running at right angles to each other, and pixel electrodes connected to the switching elements are provided. On the other of the glass substrates, components such as a counter electrode and a color filter having R(Red), G(Green), and B(Blue) color sections arranged in a predetermined pattern are provided.

The backlight device (as a lighting device) 12 is a so-called direct-light type backlight device that includes a plurality of linear light sources (e.g., cold cathode tubes 17 as high-pressure discharge tubes, in the present embodiment), which are positioned directly below the back surface of the liquid crystal panel 11 (i.e., the panel surface on the opposite side of the display side), and are arranged along the panel surface.

More specifically, the backlight device 12 includes a chassis 14 having a substantially box-like shape with an opening on its upper side, and an optical member 15 arranged to cover in the opening of the chassis 14. Further included is a frame 16 arranged to hold the optical member 15 on the chassis 14. The chassis 14 contains the cold cathode tubes 17, lamp holders 18 arranged to collectively cover the end portions of the cold cathode tubes 17, and lamp clips 19 arranged to mount the cold cathode tubes 17 on the chassis 14. Note that the optical member 15 side of the cold cathode tubes 17 corresponds to the light emitting side of the backlight device 12.

Each of the cold cathode tubes 17 forms an elongated tubular shape, and is contained in the chassis 14 so that the longitudinal direction (or axial direction) thereof conforms with the long-side direction of the chassis 14. The array of the cold cathode tubes forms a planar shape as a whole. Referring to FIG. 3, a narrow-interval area 17a where the arrangement intervals between the cold cathode tubes 17 are relatively narrow is provided, which is positioned in the array direction of the cold cathode tubes 17 so as to be on the center side (i.e., positioned at the central area of the backlight device 12). Further, wide-interval areas 17b where the arrangement intervals between the cold cathode tubes 17 are relatively wide are provided, which are positioned in the array direction of the cold cathode tubes 17 so as to be on the end sides (i.e., positioned at the end areas of the backlight device 12). Specifically, the arrangement intervals between the cold cathode tubes 17 are set to increase gradually along the short side of the backlight device 12 from the central area toward the end areas.

The chassis 14 is formed of a metallic plate. A light reflecting sheet 20 is provided on the chassis 14 so as to form a light reflecting surface, which is arranged on the side of the cold cathode tubes 17 that corresponds to the opposite side of the light emitting side. The chassis 14 thus includes the light reflecting sheet 20, and thereby the lights from the cold cathode tubes 17 can be reflected to the optical member 15.

The optical member 15 has functions such as a function for converting linear lights from the cold cathode tubes 17 as linear light sources into flat lights. In the present embodiment, the optical member 15 includes a diffuser plate 31, a diffusing sheet 32, a lens sheet 33 and a reflective polarizing plate 34, which are stacked in this order from the cold cathode tube 17 side. As shown in FIG. 3, the optical member 15 is arranged parallel to the planar shape of the array of the cold cathode tubes 17. That is, the distance between the diffuser plate 31 as the cold cathode tube 17 side member of the optical member 15 and the cold cathode tubes 17 is set to be constant along the surface of the diffuser plate 31.

A dot pattern formed of an array of a plurality of white-colored dots 40 is provided on the surface of the diffuser plate 31 facing the cold cathode tubes 17. The dots 40 can be formed on the surface of the diffuser plate 31 by printing, using a paste material that includes a fluorescent whitener, for example. Ink jet printing or gravure printing can be cited as suitable printing means therefor. The dots 40 have a light reflectivity of 99%, while the diffuser plate 31 has a light reflectivity of 60%. That is, the areas having the dots 40 formed thereon can reflect a larger amount of light. Although the diffuser plate 31 having a light reflectivity of 60% is employed in the present embodiment, another diffuser plate may be suitably selected from those between 40% and 80% in light reflectivity.

Referring to FIG. 4, the arrangement pattern of the dots 40 includes a plurality of dots 40 arranged in rows along the long-side direction of the diffuser plate 31 (i.e., along the axial direction of the cold cathode tubes 17). These rows of dots 40 along the axial direction of cold cathode tubes 17 are arranged in the short-side direction of the diffuser plate 31 (i.e., in the array direction of the cold cathode tubes 17) so as to be parallel to one another.

The planar dimensions (or sizes) of dots 40 arranged in rows are set as follows: On the rows located at the area of the diffuser plate 31 facing the narrow-interval area 17a (i.e., the area of the diffuser plate 31 corresponding to the center of its short side), the dots 40 are set to be relatively large in planar dimension. On the rows facing the wide-interval areas 17b (i.e., the rows located at the areas of the diffuser plate 31 corresponding to the ends of its short side), the dots 40 are set to be relatively small in planar dimension. Specifically, the planar dimensions are set to decrease consecutively and gradually from the rows facing the narrow-interval area 17a toward the rows facing the wide-interval areas 17b. The dots 40 located at the end areas of the diffuser plate 31 corresponding to the ends of its short side are sized so as not to be clearly visible. Further, a viewer of the present television receiver TV cannot see the boundary between the end area and the marginal area located further laterally thereto (or specifically, the marginal area arranged adjacent to the end area in the short-side direction of the diffuser plate 31) on which dots 40 are not formed.

The intervals between dots 40 are set as follows: The intervals between dots 40 adjacently arranged along the axial direction of the cold cathode tube 17 (i.e., along the long-side direction of the diffuser plate 31) are set to be constant.

On the other hand, the intervals between dots 40 adjacently arranged along the array direction of the cold cathode tubes 17 (i.e., along the short-side direction of the diffuser plate 31) are set as follows: In the area of the diffuser plate 31 facing the narrow-interval area 17a, the dots 40 are arranged densely or at relatively small intervals. In the areas of the diffuser plate 31 facing the wide-interval areas 17b, the dots 40 are arranged sparsely or at relatively large intervals. Specifically, the intervals between dots 40 are set to increase consecutively and gradually from the rows facing the narrow-interval area 17a toward the rows facing the wide-interval areas 17b.

In the dot pattern of the present embodiment, as described above, the planar dimensions of the dots 40 are set to decrease consecutively while the intervals between dots 40 are set to increase consecutively, from the area facing the narrow-interval area 17a of the cold cathode tubes 17 toward the areas facing the wide-interval areas 17b. In this way, the dot-pattern ratio, i.e., the ratio of the areas occupied by the dots 40 in the entire diffuser plate 31, is set to decrease continuously and gradually from the area facing the narrow-interval area 17a toward the areas facing the wide-interval areas 17b.

The television receiver TV thus constructed according to the present embodiment can provide the following operational effects.

In the backlight device 12 included in the television receiver TV of the present embodiment, the cold cathode tubes 17 are arranged so that the narrow-interval area 17a where the arrangement interval thereof is relatively narrow and the wide-interval areas 17b where the arrangement interval is relatively wide are provided. Specifically, the narrow-interval area 17a is arranged on the center side of the backlight device 12, while the wide-interval areas 17b are arranged on the end sides of the backlight device 12.

According to the construction, the illumination brightness can be higher at the narrow-interval area 17a than at the wide-interval areas 17b, and consequently the liquid crystal display device 10 can have improved visibility at the center of the screen. Further, the provision of the wide-interval areas 17b can lead to reduction in number of cold cathode tubes 17, resulting in cost reduction.

However, it is extremely difficult to arrange the narrow-interval area 17a capable of providing relatively high illumination brightness and the wide-interval areas 17b capable of providing relatively low illumination brightness, in a balanced manner. If the illumination brightness differs excessively between the narrow-interval area 17a and the wide-interval areas 17b, the entire distribution of illumination brightness may be provided as an uneven distribution, resulting in brightness unevenness in the liquid crystal display device 10.

In view of this, according to the present embodiment, the dot pattern formed of dots 40, which differ from the diffuser plate 31 in light reflectivity, is additionally provided on the diffuser plate 31, as regulating means for illumination brightness. The light reflectivity provided by a combination of the diffuser plate 31 and the dots 40 is set to decrease continuously and gradually from the area corresponding to the narrow-interval area 17a toward the areas corresponding to the wide-interval areas 17b.

In the present construction where the lights from the cold cathode tubes 17 are reflected by the diffuser plate 31 and the dots 40, the amounts of light to be transmitted and light to be reflected can be thereby controlled for each area of the diffuser plate 31, which enables partial regulation of the illumination brightness. That is, the light reflectivity of the diffuser plate 31 can be set to be relatively high at the area corresponding to the narrow-interval area 17a prone to relatively high illumination brightness, while it can be set to be relatively low at the areas corresponding to the wide-interval areas 17b prone to relatively low illumination brightness. Thus, the adjustment of illumination brightness between the narrow-interval area 17a and the wide-interval areas 17b can be achieved. Consequently, the illumination brightness can be gently distributed over the backlight device 12, and thereby display unevenness such as brightness unevenness described above can be prevented or suppressed in the liquid crystal display device 10 that uses the present backlight device 12.

Particularly, in the present embodiment, the light reflectivity provided by a combination of the diffuser plate 31 and the dots 40 is set to decrease continuously from the area corresponding to the narrow-interval area 17a toward the areas corresponding to the wide-interval areas 17b. Compared to varying the light reflectivity step by step, for example, the present construction can provide a further gentle distribution of illumination brightness, because the illumination brightness can vary continuously instead of step by step.

In the present embodiment, the dots 40 have a light reflectivity higher than that of the diffuser plate 31, and the dot pattern formed of the dots 40 is provided so that the dot-pattern ratio decreases continuously from the area corresponding to the narrow-interval area 17a toward the areas corresponding to the wide-interval areas 17b.

According to the construction, the lights reflected by the dots 40 having a higher light reflectivity than the diffuser plate 31 can be reflected again by the light reflecting sheet 20 so as to enter the diffuser plate 31 again. In this way, the lights from the cold cathode tubes 17 can be effectively used. Further, even at the wide-interval areas 17b prone to relatively low illumination brightness, the brightness can be enhanced by the repetitive reflection between the dots 40 and the light reflecting sheet 20.

In the present construction, the amount of light to be reflected by a combination of the diffuser plate 31 and the dots 40 increases with increase in the dot-pattern ratio. Accordingly, the amount of light to be reflected decreases continuously while the amount of light to be transmitted through the diffuser plate 31 increases continuously, from the narrow-interval area 17a toward the wide-interval areas 17b. In this way, the amount of light to be reflected is set to be large at the narrow-interval area 17a prone to relatively high illumination brightness, while it is set to be small at the wide-interval areas 17b prone to relatively low illumination brightness. Consequently, the illumination brightness can be gently distributed over the entire backlight device 12.

Hereinafter, referring to FIG. 5, the effect of the dots 40 will be explained in detail.

The lights emitted from the cold cathode tubes 17 partly enter the exposed areas of the diffuser plate 31 on which dots 40 are not formed. The lights incident on the exposed areas are partly transmitted as a transmitted light La while the lights are partly reflected as a reflected light Ra. Similarly, the lights incident on the areas having the dots 40 formed thereon are partly transmitted as a transmitted light Lb while the lights are partly reflected as a reflected light Rb. At the time, the amounts of the transmitted lights La, Lb satisfy the inequality “La>Lb”, because the light reflectivity of the dots 40 is set to be higher than that of the diffuser plate 31. In this way, the amount of light to be transmitted through the diffuser plate 31 can be controlled by arranging the dots 40 thereon, which enables the regulation of illumination brightness.

By the light reflecting sheet 20 arranged across the cold cathode tubes 17 from the diffuser plate 31, the reflected lights Ra, Rb can be reflected again as secondary reflected lights Raa, Rbb, which can enter the diffuser plate 31 again. At the time, the amounts of the reflected lights Ra, Rbb satisfy the inequality “Ra<Rb”, because the light reflectivity of the dots 40 is set to be higher than that of the diffuser plate 31. Further, the amounts of the secondary reflected lights Raa, Rbb satisfy the inequality “Raa<Rbb”, because the light reflecting sheet 20 has a constant light reflectivity. The reflected light Rb from the dots 40 and the secondary reflected light Rbb are thus provided for effective use according to the present construction, because the dots 40 are not provided simply as light blocking materials (or light absorbing materials) but rather as highly light-reflective materials. Consequently, the illumination brightness can be gently distributed over the entire backlight device 12, without large loss of the lights.

Further, in the present embodiment, the distance between the diffuser plate 31 and the array of the cold cathode tubes 17 is set to be constant along the surface of the diffuser plate 31.

If the distance between the diffuser plate 31 and the cold cathode tubes 17 is not constant, the amount of emitted light reaching the diffuser plate 31 differs among the cold cathode tubes 17. In this case, the cold cathode tubes 17 arranged at a relatively small distance from the diffuser plate 31 may be visible as lamp images. In view of this, according to the present embodiment, the distance between the diffuser plate 31 and the cold cathode tubes 17 is set to be constant. Consequently, the visible images of lamps may be prevented, and a high quality of display can be achieved.

In the present embodiment, the dots 40 include a plurality of dots arranged along the array direction of the cold cathode tubes 17, and the intervals between dots 40 adjacently arranged along the array direction are set to increase consecutively and gradually from the area corresponding to the narrow-interval area 17a toward the areas corresponding to the wide-interval areas 17b.

Further, in the present embodiment, the planar dimensions of the dots 40 are set to decrease consecutively and gradually from the area corresponding to the narrow-interval area 17a toward the areas corresponding to the wide-interval areas 17b.

According to the construction, the dot-pattern ratio can be higher at the area corresponding to the narrow-interval area 17a than at the areas corresponding to the wide-interval areas 17b. The dots 40 have a higher light reflectivity than the diffuser plate 31, and therefore the amount of light to be reflected can be larger (i.e., the amount of light to be transmitted through the diffuser plate 31 can be smaller) at the narrow-interval area 17a due to the higher dot-pattern ratio. Thus, the illumination brightness at the narrow-interval area 17a is reduced, and thereby the difference in brightness between the narrow-interval area 17a and the wide-interval areas 17b can be reduced.

In the present embodiment, the dots 40 are colored with white.

Further, in the present embodiment, the dots 40 include a fluorescent whitener.

Due to the whiter color of dots 40 and the fluorescent whitener included therein, the dots 40 can be highly light-reflective, and therefore can differ more greatly in light reflectivity from the diffuser plate 31. Consequently, the dot pattern can function as a regulator for light reflection, more effectively.

Moreover, in the present embodiment, the plurality of dots 40 included in the dot pattern are arranged in parallel lines.

According to the construction, the light reflection can be regulated with improved accuracy, due to the regular arrangement of dots 40.

In the present embodiment, the dot pattern is formed on the diffuser plate 31 by printing.

The dot pattern, which is thus to be formed by a simple method, can be arbitrarily designed and be readily formed as designed.

### Embodiment 2

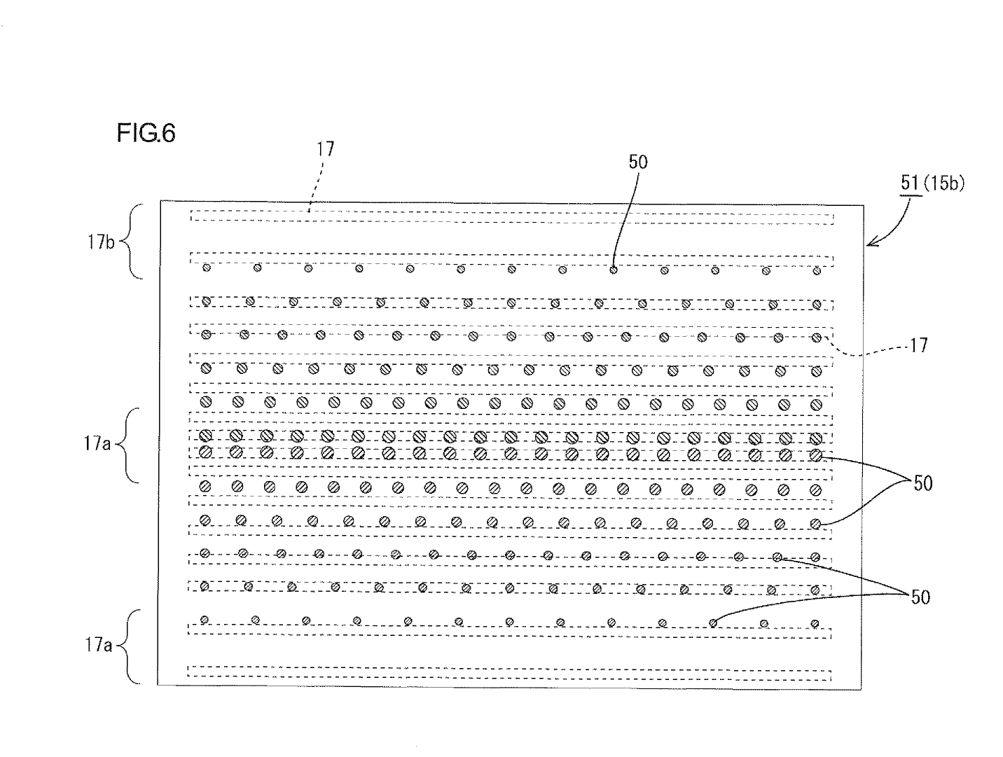

Hereinafter, an embodiment 2 of the present invention will be explained with reference to FIG. 6. The present embodiment 2 shows a modification in which the arrangement pattern of dots is changed. The other constructions are similar to the above embodiment 1. Therefore, the same parts as the above embodiment 1 are designated by the same symbols, and redundant explanations are omitted.

FIG. 6 is a plan view schematically showing the construction of a diffuser plate arranged in a liquid crystal display device.

The liquid crystal display device 10 includes an optical member 15b, which is arranged on the light emitting side of the cold cathode tubes 17 and includes a diffuser plate 51. Referring to FIG. 6, a dot pattern formed of an array of a plurality of white-colored dots 50 is provided on the surface of the diffuser plate 51 facing the cold cathode tubes 17. The dots 50 include a fluorescent whitener, so as to have a light reflectivity higher than that of the diffuser plate 51.

The arrangement pattern of the dots 50 includes a plurality of dots 50 arranged in rows along the long-side direction of the diffuser plate 51 (i.e., along the axial direction of the cold cathode tubes 17). These rows of dots 50 along the axial direction of cold cathode tubes 17 are arranged in the short-side direction of the diffuser plate 51 (i.e., in the array direction of the cold cathode tubes 17) so as to be parallel to one another.

The planar dimensions (or sizes) of dots 50 arranged in rows are set as follows: On the rows located at the area of the diffuser plate 51 facing the narrow-interval area 17a (i.e., the area of the diffuser plate 51 corresponding to the center of its short side), the dots 50 are set to be relatively large in planar dimension. On the rows facing the wide-interval areas 17b (i.e., the rows located at the areas of the diffuser plate 51 corresponding to the ends of its short side), the dots 50 are set to be relatively small in planar dimension. Specifically, the planar dimensions are set to decrease consecutively and gradually from the rows facing the narrow-interval area 17a toward the rows facing the wide-interval areas 17b. The dots 50 located at the end areas of the diffuser plate 51 corresponding to the ends of its short side are sized so as not to be clearly visible.

The intervals between dots 50 are set as follows: As for the intervals between dots 50 adjacently arranged along the axial direction of the cold cathode tube 17 (i.e., along the long-side direction of the diffuser plate 51), the dots 50 are arranged densely or at relatively small intervals, in the area of the diffuser plate 51 facing the narrow-interval area 17a. On the other hand, the dots 50 are arranged sparsely or at relatively large intervals, in the areas of the diffuser plate 51 facing the wide-interval areas 17b. Specifically, the intervals between dots 50 adjacently arranged along the axial direction are set to increase consecutively and gradually from the rows facing the narrow-interval area 17a toward the rows facing the wide-interval areas 17b. In the present embodiment, the intervals between dots 50 adjacently arranged along the array direction of the cold cathode tubes 17 (i.e., along the short-side direction of the diffuser plate 51) are set to be constant.

In the dot pattern of the present embodiment, as described above, the planar dimensions of the dots 50 are set to decrease consecutively while the intervals between dots 50 are set to increase consecutively, from the area facing the narrow-interval area 17a of the cold cathode tubes 17 toward the areas facing the wide-interval areas 17b. In this way, the dot-pattern ratio, i.e., the ratio of the areas occupied by the dots 50 in the entire diffuser plate 51, is set to decrease continuously and gradually from the area facing the narrow-interval area 17a toward the areas facing the wide-interval areas 17b.

In the backlight device 12 of the present embodiment, as described above, the dots 50 having a higher light reflectivity than the diffuser plate 51 are provided on the diffuser plate 51. The dots 50 include a plurality of dots arranged along the axial direction of the cold cathode tube 17, and the intervals between dots 50 adjacently arranged along the axial direction are set to increase consecutively and gradually from the area facing the narrow-interval area 17a toward the areas facing the wide-interval areas 17b.

Further, in the present embodiment, the planar dimensions of the dots 50 are set to decrease consecutively and gradually from the area facing the narrow-interval area 17a toward the areas facing the wide-interval areas 17b.

According to the construction, the dot-pattern ratio can be higher at the area corresponding to the narrow-interval area 17a than at the areas corresponding to the wide-interval areas 17b. The dots 50 have a higher light reflectivity than the diffuser plate 51, and therefore the amount of light to be reflected can be larger (i.e., the amount of light to be transmitted through the diffuser plate 51 can be smaller) at the narrow-interval area 17a due to the higher dot-pattern ratio. Thus, the illumination brightness at the narrow-interval area 17a is reduced, and thereby the difference in brightness between the narrow-interval area 17a and the wide-interval areas 17b can be reduced. The dot pattern provided in the present embodiment is more effective as regulating means for brightness, when the narrow-interval area 17a and the wide-interval areas 17b greatly differ in brightness.

### Embodiment 3

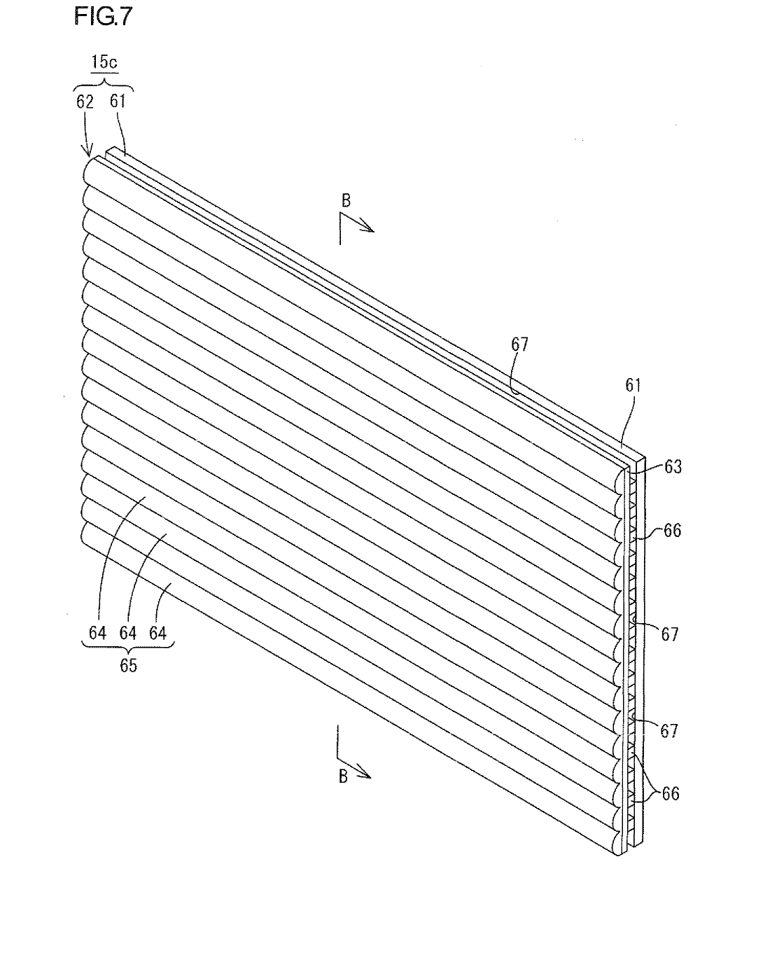

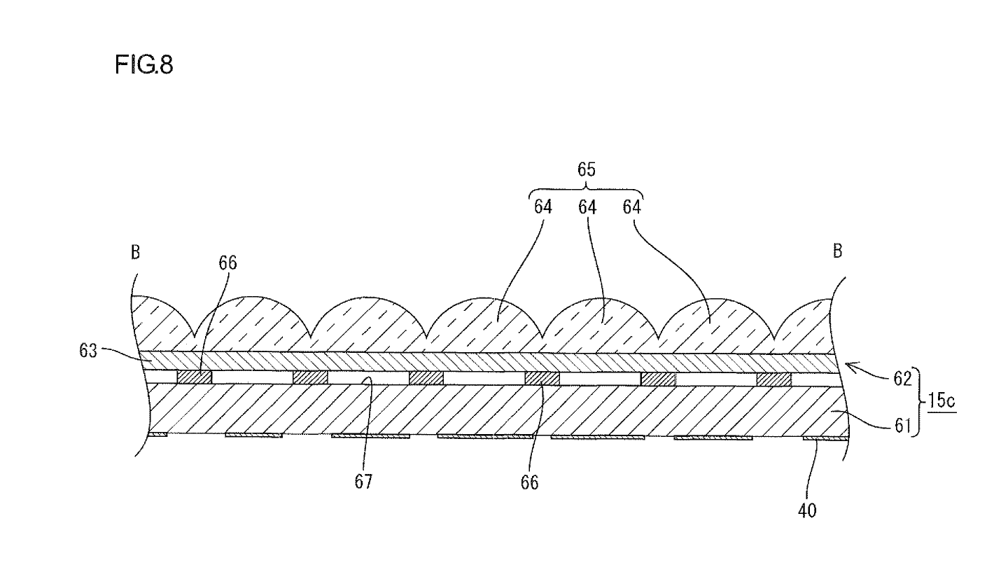

Hereinafter, an embodiment 3 of the present invention will be explained with reference to FIGS. 7 and 8. The present embodiment 3 shows a modification in which an optical member having dots formed thereon is changed in construction. The other constructions are similar to the above embodiment 1. Therefore, the same parts as the above embodiment 1 are designated by the same symbols, and redundant explanations are omitted.

FIG. 7 is a sectional view showing the construction of the optical member to be arranged in a liquid crystal display device. FIG. 8 is a plan view schematically showing the construction of a diffuser plate included in the optical member.

The optical member 15c arranged in the liquid crystal display device 10 has a horizontally-elongated rectangular shape, similar to those of the liquid crystal panel 11 and the chassis 14. Referring to FIGS. 7 and 8, the optical member 15c includes a diffuser plate 61 and a lens sheet 62, which are attached to each other so as to face each other. The optical member 15c is arranged in the opening of the chassis 14, so that the diffuser plate 61 faces the cold cathode tubes 17 while the lens sheet 62 faces the liquid crystal panel 11.

The diffuser plate 61 is arranged to diffuse incoming light, and has a construction in which light-scattering particles capable of scattering lights are dispersed or contained in a light transmissive base member formed of polystyrene. Dots 40 having a higher light reflectivity than the diffuser plate 61 are formed on the surface of the diffuser plate 61 facing the cold cathode tubes 17, in a similar manner to the above embodiment 1 (See FIG. 4). Although the base member formed of polystyrene is used in the present embodiment, the material therefor may be suitably selected from other synthetic resins, such as polycarbonate or polymethylmethacrylate.

The lens sheet 62 includes a lens section 65 formed of a plurality of convex cylindrical lenses 64 arranged parallel on a light transmissive base member 63, e.g., made of polyethylene terephthalate, and thereby has a light-condensing anisotropic nature (i.e., the nature by which the light concentration is selectively performed with respect to a specific direction). In the present embodiment, the lens section 65 is made of acrylic. The convex cylindrical lenses 64, each of which is formed of a semicircular column-shaped convex lens arranged to extend in the long-side direction of the base member, are arranged in the short-side direction so as to be parallel to one another. That is, the extending direction of the convex cylindrical lenses 64 conforms with the axial direction of the cold cathode tubes 17. Although the light transmissive base member 63 made of polyethylene terephthalate is used in the present embodiment, the material therefor may be suitably selected from other synthetic resins, such as polycarbonate or polymethylmethacrylate.

Reflective layer 66 is provided between the diffuser plate 61 and the lens sheet 62, and is selectively arranged in a striped configuration so as to overlap with the boundary areas between the convex cylindrical lenses 64, when viewed planarly. Light transmitting sections 67 are provided between adjacent sections of the reflective layer 66, so as to overlap with the focal positions of the convex cylindrical lenses 64, when viewed planarly. The reflective layer 66 and the light transmitting sections 67 are both formed of linear-shaped sections, which individually have a predetermined width and are arranged substantially parallel to the longitudinal direction of the convex cylindrical lenses 64 so as to form a striped configuration as a whole.

Each section of the reflective layer 66 is located so that the center of its predetermined width corresponds to the valley between the convex cylindrical lenses 64. Each light transmitting section 67 is located so that the center of its predetermined width corresponds to the vertex of the convex cylindrical lens 64. The reflective layer 66 is formed of a resin base member in which titanium-oxide microparticles with white color are dispersed or mixed, for example. On the other hand, the light transmitting sections 67 are provided as airspaces, which differ in index of refraction from the diffuser plate 61 or the lens sheet 62. The arrangement interval between the convex cylindrical lenses 64 (i.e., lens pitch) and the arrangement interval between the reflective layer sections 66 (i.e., reflective-layer-section pitch) are set to be substantially equal to each other, which can be set to around 140 μm, for example.

In the optical member 15c described above, the applied lights from the cold cathode tubes 17 are diffused by the diffuser plate 61, and thereafter enter the convex cylindrical lenses 64 if they can pass through the light transmitting sections 67. Then, the lights are outputted therefrom while being directed to the effective display area of the liquid crystal panel 11. On the other hand, the lights other than those passing through the light transmitting sections 67 are reflected to the cold cathode tube 17 side by the reflective layer 66, and thereafter are directed again to the optical member 15c side by the light reflecting sheet 20 and the like. In this way, the lights can pass through the light transmitting sections 67 after repeated reflections. Thus, the present construction can achieve the recycling of lights.

According to the present embodiment, as describe above, the optical member 15c included in the liquid crystal display device 10 has the lens sheet 62, which is formed of an array of a plurality of convex cylindrical lenses 64 and is attached to the surface of the diffuser plate 61 that is on the opposite side of its surface facing the cold cathode tubes 17.

According to the construction, the lights after being diffused by the diffuser plate 61 can pass through the convex cylindrical lenses 64 of the lens sheet 62, and thereby the irradiation light can be condensed into the effective display area of the liquid crystal panel 11 with high efficiency.

Further, in the present embodiment, the reflective layer 66 is provided between the diffuser plate 61 and the lens sheet 62. The reflective layer 66 is selectively arranged to correspond to the boundary areas between the convex cylindrical lenses 64.

That is, the reflective layer 66 is arranged to correspond to the non-converging sections of the convex cylindrical lenses 64, while the light transmitting sections 67 are arranged between adjacent sections of the reflective layer 66 so as to correspond to the converging sections of the convex cylindrical lenses 64. According to the construction, the light diffusion angle or the light converging angle) can be readily controlled by adjusting the area ratio between the reflective layer sections 66 and the light transmitting sections 67. Thereby, in the present liquid crystal display device 10, the lights to be directed to the nondisplay area can be reduced, resulting in improvement in light use efficiency.

Moreover, in the optical member 15c, the dots 40 having a higher light reflectivity than the diffuser plate 61 are provided on the surface of the diffuser plate 61 facing the cold cathode tubes 17. In the dot pattern formed of the dots 40, the planar dimensions of the dots 40 are set to decrease consecutively while the intervals between dots 40 are set to increase consecutively, from the area facing the narrow-interval area 17a of the cold cathode tubes 17 toward the areas facing the wide-interval areas 17b.

According to the construction, the light reflectivity of the diffuser plate 61 can be relatively high at the area corresponding to the narrow-interval area 17a prone to relatively high illumination brightness, while it can be relatively low at the areas corresponding to the wide-interval areas 17b prone to relatively low illumination brightness. Thus, the adjustment of illumination brightness between the narrow-interval area 17a and the wide-interval areas 17b can be achieved. Consequently, the illumination brightness can be gently distributed over the backlight device 12, and thereby display unevenness such as brightness unevenness described above can be prevented or suppressed in the liquid crystal display device 10 that uses the present backlight device 12.

Particularly, in the present embodiment, the light reflectivity provided by a combination of the diffuser plate 61 and the dots 40 is set to decrease continuously from the area corresponding to the narrow-interval area 17a toward the areas corresponding to the wide-interval areas 17b. Compared to varying the light reflectivity step by step, for example, the present construction can provide a further gentle distribution of illumination brightness, because the illumination brightness can vary continuously instead of step by step.

Moreover, as a result of repetitive reflection between the dots 40 or the reflective layer 66 and the light reflecting sheet 20 individually having a high light reflectivity, the lights can reach all parts of the backlight device 12. Consequently, the brightness can be enhanced even at the wide-interval areas 17b prone to relatively low illumination brightness. In this way, a uniform distribution of illumination brightness can be provided while the reduction in the overall brightness of the backlight device 12 is suppressed.

### Other Embodiments

Shown above are embodiments of the present invention. However, the present invention is not limited to the embodiments explained in the above description made with reference to the drawings. The following embodiments may be included in the technical scope of the present invention, for example.

(1) In the above embodiments, the dots formed on the diffuser plate have a higher light reflectivity than that of the diffuser plate. However, the light reflectivity of the dots may be set to any value different from that of the diffuser plate. Still, it is preferable to set the light reflectivity of the dots to be higher than that of the diffuser plate, in order to achieve the recycling of lights and thereby prevent the reduction in the overall brightness of the backlight device 12.

(2) In the above embodiments, the dots including a fluorescent whiter are formed on the diffuser plate by printing. However, the dots may have any composition as long as they can be highly light-reflective. For example, the dots may be formed to have surfaces with metallic luster.

(3) In the above embodiments, the dots are formed on the diffuser plate by printing. However, in the case that the dots include metal as a constituent material, for example, another formation method such as metal deposition may be used, instead. In this case, it is preferable to mask the areas unrelated to the dot formation during the deposition.

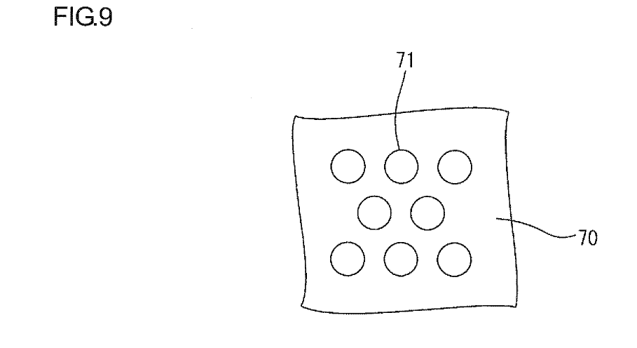

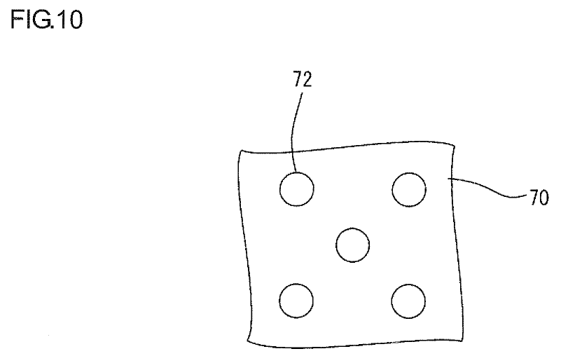

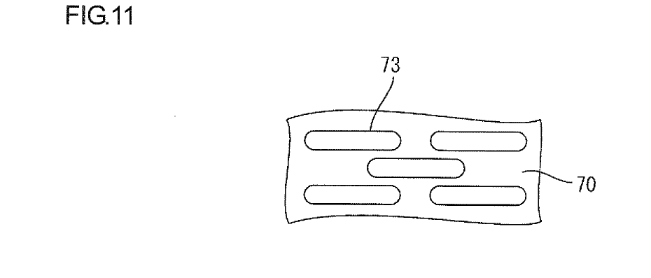

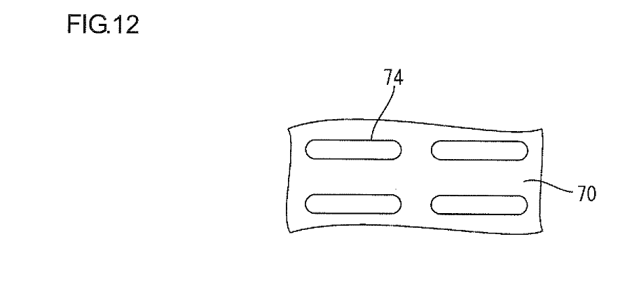

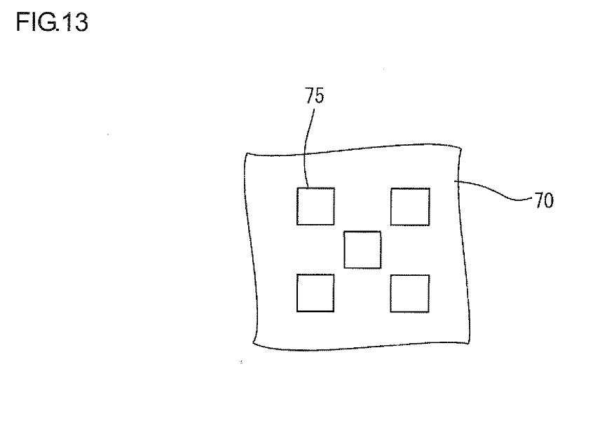

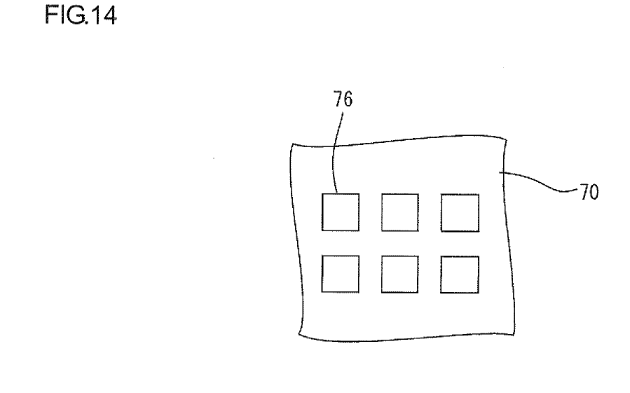

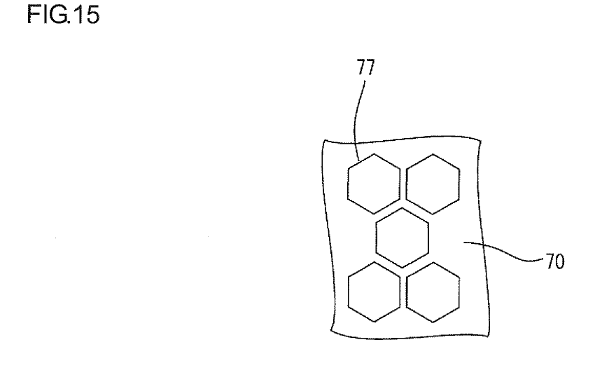

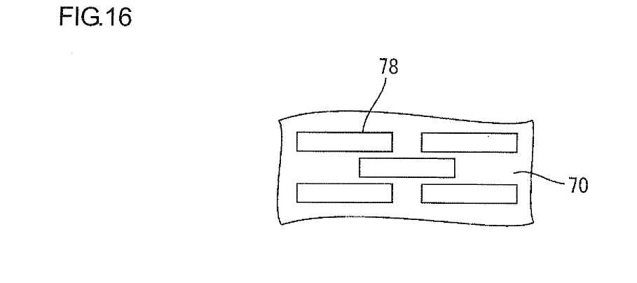

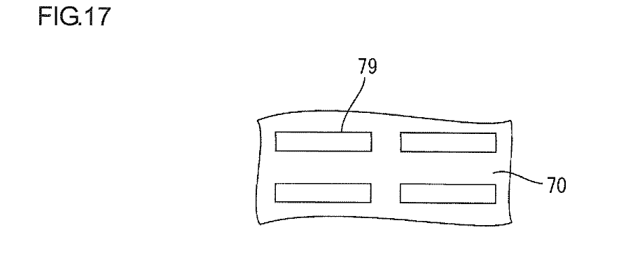

(4) In the above embodiments, the dots having circular shapes are arranged in parallel lines (to form an in-line arrangement of circular dots). However, the shapes and arrangement of dots are not limited to this configuration. For example, on a diffuser plate 70, referring to FIG. 9, dots 71 having a circular shape may be arranged in a zigzag pattern with 60-degree angles to form a 50-degree zigzag arrangement of circular dots. Alternatively, referring to FIG. 10, dots 72 having a circular shape may be arranged in a zigzag pattern with 90-degree angles to form a right-angled zigzag arrangement of circular dots. As shown in FIG. 11, dots 73 having an oval shape may be arranged in a zigzag pattern to form a zigzag arrangement of oval dots. As shown in FIG. 12, dots 74 having an oval shape may be arranged in parallel lines to form an in-line arrangement of oval dots. As shown in FIG. 13, dots 75 having a square shape may be arranged in a zigzag pattern to form a zigzag arrangement of square dots. As shown in FIG. 14, dots 76 having a square shape may be arranged in parallel lines to form an in-line arrangement of square dots. As shown in FIG. 15, dots 77 having a hexagonal shape may be arranged in a zigzag pattern with 60-degree angles to form a 50-degree zigzag arrangement of hexagonal dots. As shown in FIG. 16, dots 78 having a rectangular shape may be arranged in a zigzag pattern to form a zigzag arrangement of rectangular dots. As shown in FIG. 17, dots 79 having a rectangular shape may be arranged in parallel lines to form an in-line arrangement of rectangular dots.

(5) In the above embodiments, the dots have the same shape as one another. However, dots having different shapes may be provided on a diffuser plate.

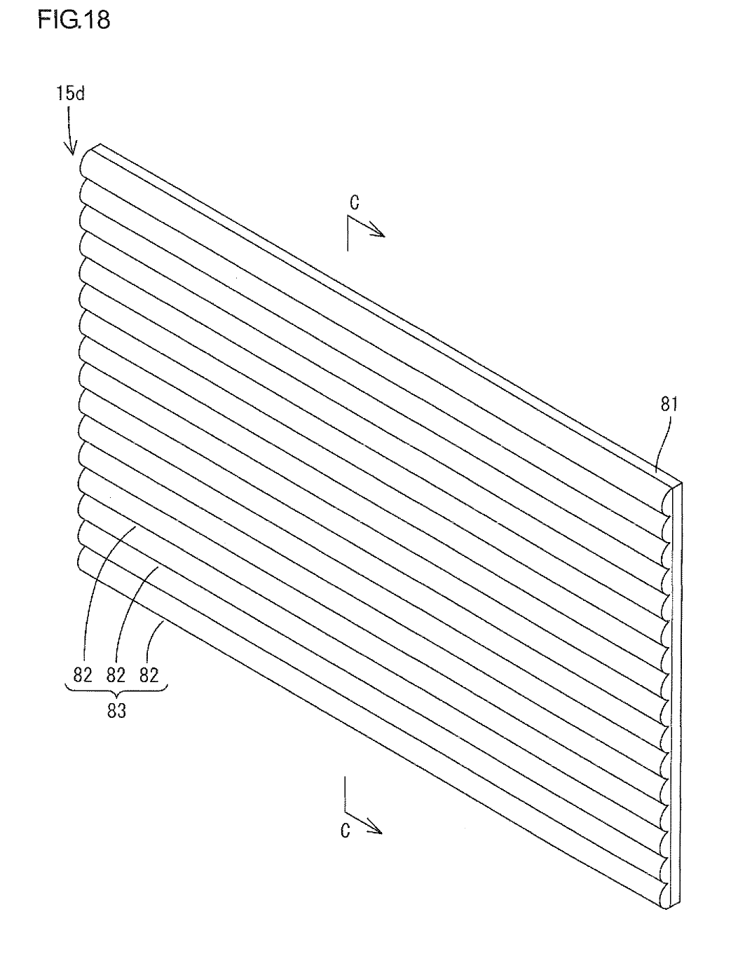

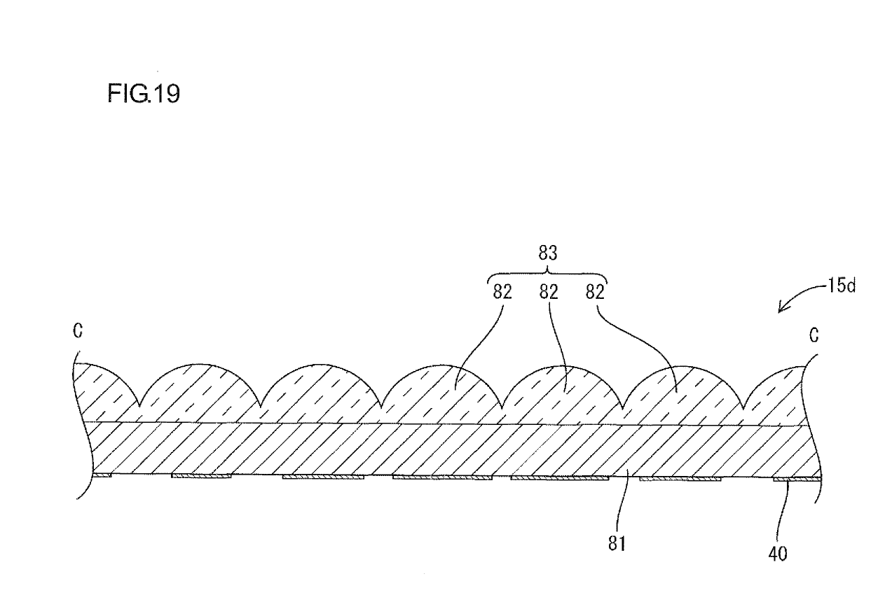

(6) In the above embodiment 3, the optical member 15c includes a lens sheet 62, which is attached to the diffuser plate 61 and includes a plurality of convex cylindrical lenses 64. However, the means for providing a light-condensing anisotropic nature is not limited to this construction. For example, an optical member 15d may have a construction shown in FIGS. 18 and 19. According to the construction, the optical member 15d includes a lens pattern 83, which is formed of an array of a plurality of lenses 82 and is arranged on the surface of a diffuser plate 81 that is on the opposite side of its surface facing the cold cathode tubes 17.

(7) In the above embodiments, the narrow-interval area 17a is positioned in the array direction of the cold cathode tubes 17 so as to be on the center side, while the wide-interval areas 17b are positioned in the array direction of the cold cathode tubes 17 so as to be on the end sides. However, a narrow-interval area and a wide interval area may be located at any position. Particularly in the case that a lighting device of the present invention is used for a display device, it is preferable that a narrow-interval area is positioned in the array direction of cold cathode tubes so as to be on the inner side of a wide-interval area, because the display device is required to have relatively high brightness at the center of the screen.

(8) In the above embodiments, the cold cathode tubes 17 are used as light sources. However, the present invention can include a construction in which another type of light sources such as hot cathode tubes is used, for example.

(9) In the above embodiments, TFTs are used as switching elements of the liquid crystal display device 10. However, the present invention can be applied to a liquid crystal display device that uses another type of switching elements than TFTs (e.g., thin-film diodes (TFDs)). Further, the present invention can be applied to a liquid crystal display device for monochrome display, as well as a liquid crystal display device capable of color display.

(10) In the above embodiments, the liquid crystal display device 10 having the liquid crystal panel 11 as a display panel is shown for illustrative purposes. However, the present invention can be applied to a display device that uses another type of display panel.

1. A lighting device comprising:
a plurality of linear light sources arranged parallel to one another; and
a diffuser plate arranged on a light emitting side of said linear light sources, wherein:
said linear light sources are arranged so that a narrow-interval area where an arrangement interval thereof is relatively narrow and a wide-interval area where the arrangement interval is relatively wide are provided;
a dot pattern as an array of a plurality of dots is provided on said diffuser plate;
said dots have a light reflectivity that differs from a light reflectivity of said diffuser plate; and
a light reflectivity provided by a combination of said diffuser plate and said dot pattern is set to decrease continuously and gradually from an area corresponding to said narrow-interval area toward an area corresponding to said wide-interval area.

2. A lighting device as in claim 1, wherein said narrow-interval area is positioned in an array direction of said linear light sources so as to be on a center side, and said wide-interval area is positioned in the array direction of said linear light sources so as to be on an end side.

3. A lighting device as in claim 1, wherein:
the light reflectivity of said dots is set to be higher than the light reflectivity of said diffuser plate; and
said dot pattern is provided so that a dot-pattern ratio as a ratio of an area occupied by said dot pattern in a whole of said diffuser plate decreases continuously and gradually from the area corresponding to said narrow-interval area toward the area corresponding to said wide-interval area.

4. A lighting device as in claim 1, wherein a distance between said diffuser plate and an array of said linear light sources is set to be constant along a surface of said diffuser plate.

5. A lighting device as in claim 3, wherein:
said dots include a plurality of dots arranged along an axial direction of said linear light sources; and
intervals between said dots adjacently arranged in said axial direction are set to increase consecutively and gradually from the area corresponding to said narrow-interval area toward the area corresponding to said wide-interval area.

6. A lighting device as in claim 3, wherein:
said dots include a plurality of dots arranged in an array direction of said linear light sources; and
intervals between said dots adjacently arranged in said array direction are set to increase consecutively and gradually from the area corresponding to said narrow-interval area toward the area corresponding to said wide-interval area.

7. A lighting device as in claim 3, wherein planar dimensions of said dots are set to decrease consecutively and gradually from the area corresponding to said narrow-interval area toward the area corresponding to said wide-interval area.

8. A lighting device as in claim 3, wherein said dots are colored with white.

9. A lighting device as in claim 3, wherein said dots include a fluorescent whitener.

10. A lighting device as in claim 3, wherein said dots have a surface with metallic luster.

11. A lighting device as in claim 1, wherein said plurality of dots in said dot pattern are arranged in a zigzag pattern.

12. A lighting device as in claim 1, wherein said plurality of dots in said dot pattern are arranged in parallel lines.

13. A lighting device as in claim 1, wherein said dot pattern is formed on said diffuser plate by printing.

14. A lighting device as in claim 1, wherein said dot pattern is formed on said diffuser plate by metal deposition.

15. A lighting device as in claim 1, wherein a lens sheet having an array of a plurality of lenses is attached to a surface of said diffuser plate that is on an opposite side of a surface facing said linear light sources.

16. A lighting device as in claim 15, wherein:
a reflective layer is provided between said diffuser plate and said lens sheet, so as to reflect light emitted from said linear light sources; and
said reflective layer is selectively arranged to correspond to a boundary area between said plurality of lenses.

17. A lighting device as in claim 1, wherein a lens pattern as an array of a plurality of lenses is provided on a surface of said diffuser plate that is on an opposite side of a surface facing said linear light sources.

18. A display device comprising:
a lighting device as in claim 1; and
a display panel arranged on a front side of said lighting device.

19. A display device as in claim 18, wherein said display panel is provided as a liquid crystal panel that includes a pair of substrates and liquid crystal sealed therebetween.

20. A television receiver comprising a display device as in claim 18.
